(19) United States
(12) Patent Application Publication
(10) Pub. No.: US 2016/0225191 A1
(43) Pub. Date: Aug. 4, 2016

(54) HEAD MOUNTED DISPLAY CALIBRATION

(71) Applicant: Brian Mullins, Sierra Madre, CA (US)

(72) Inventor: Brian Mullins, Sierra Madre, CA (US)

(73) Assignee: DAQRI, LLC, Los Angeles, CA (US)

(21) Appl. No.: 15/013,333

(22) Filed: Feb. 2, 2016

Related U.S. Application Data
(60) Provisional application No. 62/110,932, filed on Feb. 2, 2015.

(51) Int. Cl. G06T 19/00; G02B 27/01; G06F 3/01

(52) U.S. Cl. CPC G06T 19/006; G06F 3/013; G06F 3/012; G02B 27/0172; G02B 27/0179; G02B 2027/014; G02B 2027/0138; G02B 2027/0187

(57) ABSTRACT

Techniques of head mounted display calibration are disclosed. In some example embodiments, corresponding intrinsic calibration procedures are performed for each component in a plurality of components of a head mounted display, with each intrinsic calibration procedure comprising determining one or more intrinsic calibration parameters for the corresponding component, and a plurality of extrinsic calibration procedures are performed among the plurality of components, with each extrinsic calibration procedure comprising determining one or more extrinsic calibration parameters. An augmented reality function of the head mounted display is configured based on the determined intrinsic calibration parameters and the determined extrinsic calibration parameters, with the configured augmented reality function being configured to cause the display of virtual content on the head mounted display using the determined intrinsic and extrinsic calibration parameters in conjunction with the plurality of components.

### REFERENCE TO RELATED APPLICATION

This application claims the benefit of priority of U.S. Provisional Application No. 62/110,932, filed Feb. 2, 2015, which is hereby incorporated by reference in its entirety.

### TECHNICAL FIELD

The present application relates generally to the technical field of data processing, and, in various embodiments, to methods and systems of head mounted display calibration.

### BACKGROUND

A head-mounted display, or a heads-up display (HUD), is a transparent display that presents data without requiring its users to look away from their usual viewpoints. It typically includes a projector unit, a video generator unit, and a combiner to fuse projected data (e.g., text, symbol, image) with the live scene currently viewed by the users. A HUD system worn by a user is equipped with many real-time sensors to augment the user's sense and present all the data concisely to the user to enhance the user's ability to do whatever needs to be done.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating a head-mounted display device, in accordance with some example embodiments.

FIG. 2 illustrates coordinate systems of a head mounted display and its components, in accordance with some embodiments;

FIG. 3 illustrates a 3D to 2D perspective mapping, in accordance with some embodiments;

FIG. 4 is a block diagram illustrating a calibration system, in accordance with some embodiments;

FIG. 5 is a flowchart illustrating a method of head mounted display calibration, in accordance with some embodiments; and

FIG. 6 is a block diagram of an example computer system on which methodologies described herein may be executed, in accordance with some embodiments.

### DETAILED DESCRIPTION

Example methods and systems of head mounted display calibration are disclosed. In the following description, for purposes of explanation, numerous specific details are set forth in order to provide a thorough understanding of example embodiments. It will be evident, however, to one skilled in the art that the present embodiments may be practiced without these specific details.

In some example embodiments, a computer-implemented method comprises performing a corresponding intrinsic calibration procedure for each component in a plurality of components of a head mounted display independently of any calibration procedure for any of the other components in the plurality of components, with each corresponding intrinsic calibration procedure comprising determining one or more corresponding intrinsic calibration parameters for the corresponding component based on a calculated difference between sensed data of the corresponding component and reference data, and performing a plurality of extrinsic calibration procedures among the plurality of components, with each extrinsic calibration procedure comprising determining one or more corresponding extrinsic calibration parameters based on a calculated difference between sensed data of one of the plurality of components and sensed data of another one of the plurality of components. In some example embodiments, an augmented reality function of the head mounted display is configured based on the determined intrinsic calibration parameters and the determined extrinsic calibration parameters, with the configured augmented reality function being configured to cause the display of virtual content on the head mounted display using the determined intrinsic and extrinsic calibration parameters in conjunction with the plurality of components.

In some example embodiments, the configuring of the augmented reality function comprises configuring the augmented reality function to offset sensed data from the plurality of components based on the determined intrinsic and extrinsic calibration parameters.

In some example embodiments, the plurality of components comprises an inertial measurement unit (IMU), a range sensor, a camera for eye tracking, and at least one externally-facing camera for capturing visual content external of the head mounted display. In some example embodiments, the plurality of components further comprises at least one of a projector and a display surface.

In some example embodiments, configuring the augmented reality function comprises configuring the head mounted display based on the determined intrinsic calibration parameters and the determined extrinsic calibration parameters. In some example embodiments, configuring the head mounted display comprises configuring the plurality of components.

In some example embodiments, configuring the augmented reality function comprises configuring a computing device that is remote from the head mounted display and communicates with the head mounted display via wireless communication, the computing device being configured to provide the augmented reality function to the head mounted display.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

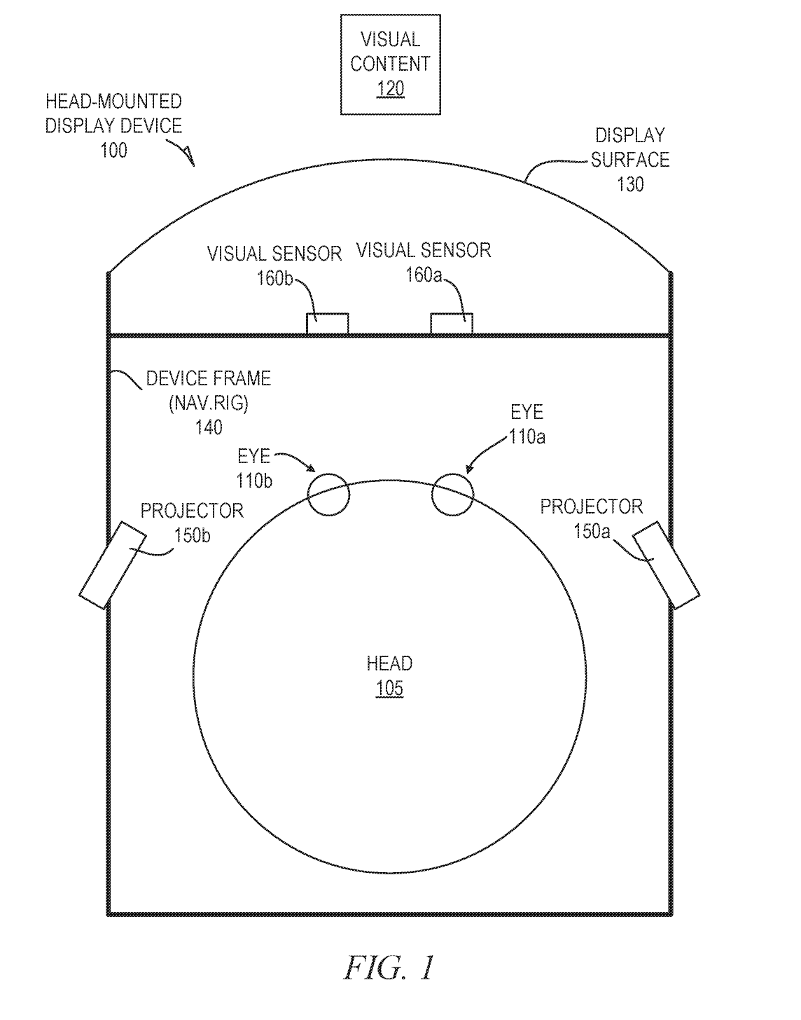

FIG. 1 is a block diagram illustrating a head-mounted display device 100, in accordance with some example embodiments. It is contemplated that the features of the present disclosure can be incorporated into the head-mounted display device 100 or into any other wearable device. In some embodiments, head-mounted display device 100 comprises a device frame 140, or navigation rig, to which its components may be coupled and via which the user can mount, or otherwise secure, the head-mounted display device 100 on the user's head 105. Although device frame 140 is shown in FIG. 1 having a rectangular shape, it is contemplated that other shapes of device frame 140 are also within the scope of the present disclosure. The user's eyes 110a and 110b can look through a display surface 130 of the head-mounted display device 100 at real-world visual content 120. In some embodiments, head-mounted display device 100 comprises one or more sensors, such as visual sensors 160a and 160b (e.g., cameras), for capturing sensor data. The head-mounted display device 100 can comprise other sensors as well, including, but not limited to, depth sensors, inertial measurement units (IMUs) with accelerometers, gyroscopes, magnometers, and barometers, and any other type of data capture device embedded within these form factors. In some embodiments, head-mounted display device 100 also comprises one or more projectors, such as projectors 150a and 150b, configured to display virtual content on the display surface 130. Display surface 130 can be configured to provide optical see-through (transparent) ability. It is contemplated that other types, numbers, and configurations of sensors and projectors can also be employed and are within the scope of the present disclosure. In some example embodiment, the head-mounted display device 100 incorporates augmented reality technology to generate and display virtual content on the display surface 130 based on a sensor data of the visual content 120 (e.g., captured image data of the visual content 120). Other augmented reality features are also within the scope of the present disclosure.

One key function for a personal HUD system is the navigation ability: users should always be able to know where they are and what they are looking at no matter where they are, indoor or outdoor. There are many component technologies available that be combined in order to help the users, including, but not limited to, Global Positioning System (GPS) technology, a camera, a 3D sensor, an IMU, and wireless localization.

In order to present the sensor-derived data to the right place, the HUD may need to know the viewpoint of a user through eye tracking. When the region of interest is identified by eye tracking, the HUD may want to render a preexisting model for the region and project overlay onto the real world or overlay location-specific information. Such overlay could have many applications, for example, change detection and augmented display. In order to render the model with the right scale, the distance from the user can be readily available from a 3D sensor.

In some example embodiments, in order to achieve the goal of presenting the right information in the right place, various installed sensors are calibrated, estimating both the intrinsic parameters of individual sensors (e.g., performance drift and noise) and extrinsic parameters between the sensors (e.g., the relative geometric relation between sensors).

### RHS Coordinate Systems and Calibration

In some example embodiments, for any calibration, coordinate systems for each component are established and they are related to each other, as well as to the world coordinate system (e.g., the GPS coordinate system). In some example embodiments, right-hand side (RHS) coordinate systems are employed.

The navigation system can comprise a rig (NavRig) with different sensors. While these sensors may be attached together rigidly, often their relative geometries are unknown or accurate knowledge is not available. In addition, the fixed geometry can drift after a certain period of time. Therefore, the present disclosure provides techniques for calibrating the coordinate systems of each sensor against the navigation rig coordinate system.

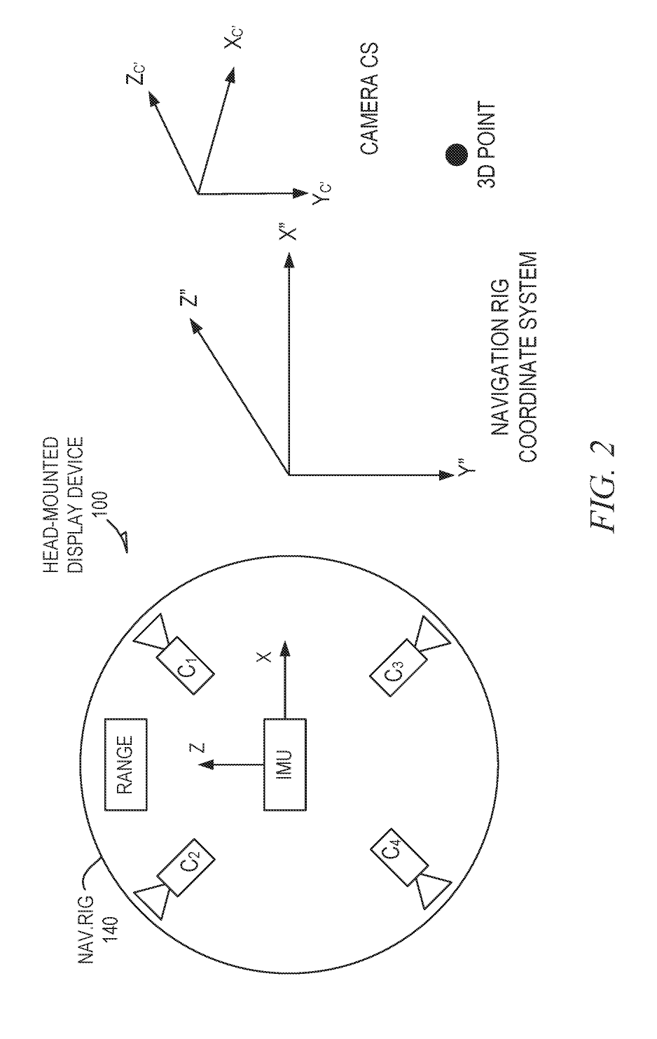

FIG. 2 illustrates coordinate systems of a head mounted display 140 and its components, in accordance with some embodiments. FIG. 2 illustrates a configuration of sensors (e.g., cameras C1, C2, C3, C4, inertial measurement unit (IMU), range sensor) on the head mounted display or navigation rig (NavRig) 140 and the associated coordinate systems (CS).

A component sensor can be described in the NavRig coordinate system by its heading and position with respect to NavRig CS: (Rₖ, tₖ). In some example embodiments, Rₖ is a rotation matrix and tₖ is the position. The task of calibrating CS of each sensor against the NavRig CS is to obtain the accurate heading and position. When (Rₖ, tₖ) is known or determined, transformation of a 3D point, represented in the NavRig CS as [X Y Z]^{T}, to the sensor CS as Mₖ:Mₙ=inv(Rₖ)*([X Y Z]^{T}−tₖ)^{T} can be performed.

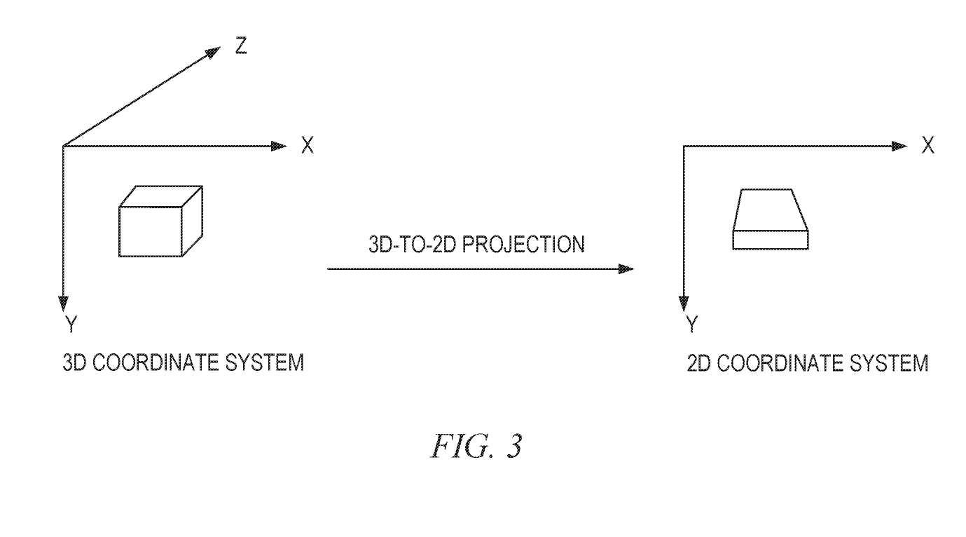

For camera sensors, there can be an additional step. In some example embodiments, a 3D point is mapped to the image plane as 2D image pixels. This is a perspective projection and involves focal length, principle point (center of projection), aspect ratio between x and y, distortion parameter of the lens. FIG. 3 illustrates a 3D to 2D perspective mapping, in accordance with some embodiments. This is also called calibration of intrinsic parameters, while the above estimate of sensor heading and position is called extrinsic parameter calibration.

In some example embodiments, the following strategy is employed for calibrating four cameras and an IMU on the NavRig 140: Step I) individual calibration of intrinsic parameters for each camera and IMU; Step II) calibration of non-overlapping cameras; and Step I) joint calibration of the calibrated cameras and the IMU.

In some example embodiments, the calibration equipment employs the following characteristics:
Accuracy in accordance with the National Institute of Standards and Technology (NIST): closeness of the agreement between the result of a measurement and the value of the measurand (a physical parameter being quantified by measurement).
Repeatability in accordance with NIST: closeness of the agreement between the results of successive measurements of the same measurand carried out under the same conditions of measurement.
Reproducibility in accordance with NIST: closeness of the agreement between the results of measurements of the same measurand carried out under changed conditions of measurement.
Precision in accordance with the International Organization for Standardization (ISO): the closeness of agreement between independent test results obtained under stipulated conditions. Further, it views the concept of precision as encompassing both repeatability and reproducibility since it defines repeatability as “precision under repeatability conditions,” and reproducibility as “precision under reproducibility conditions.” Nevertheless, precision is often taken to mean simply repeatability.

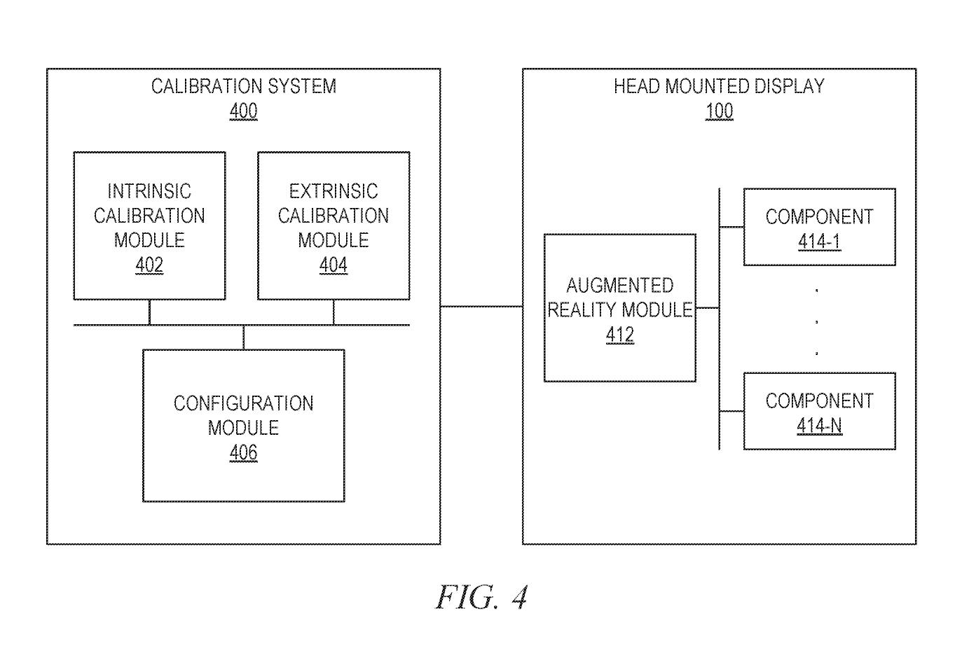

FIG. 4 is a block diagram illustrating a calibration system 400, in accordance with some embodiments. The calibration system 400 can comprise one or more special-purpose modules configured to calibrate a head mounted display 100 having an augmented reality module 412 configured to generate and display virtual content based on sensor data obtained via one or more components 414. The components 414 can comprise sensors (e.g., cameras, IMUs, eye trackers), display screens, and projectors.

In some example embodiments, the calibration system 400 comprises an intrinsic calibration module 402, an extrinsic calibration module 404, and a configuration module 406. In some example embodiments, the intrinsic calibration module 402, the extrinsic calibration module 404, and the configuration module 406 reside on the same machine, while in other example embodiments, one or more of the intrinsic calibration module 402, the extrinsic calibration module 404, and the configuration module 406 reside on separate remote machines that communicate with each other via a network. Other configurations are also within the scope of the present disclosure.

In some example embodiments, the intrinsic calibration module 402 is configured to perform a corresponding intrinsic calibration procedure for each component in a plurality of components of a head mounted display independently of any calibration procedure for any of the other components in the plurality of components (e.g., an intrinsic calibration procedure being performed on the IMU separately and independently of any intrinsic calibration procedure on any of the other components). In some example embodiments, each corresponding intrinsic calibration procedure comprises determining one or more corresponding intrinsic calibration parameters for the corresponding component based on a calculated difference between sensed data of the corresponding component and reference data (e.g., the difference between what the component senses and what is real; a measurement of the inaccuracy of the component).

In some example embodiments, the plurality of components comprises an inertial measurement unit (IMU), a range sensor, a camera for eye tracking, and at least one externally-facing camera for capturing visual content external of the head mounted display. In some example embodiments, the plurality of components further comprises at least one of a projector and a display surface.

In some example embodiments, the extrinsic calibration module 404 is configured to perform a plurality of extrinsic calibration procedures among the plurality of components (e.g., an extrinsic calibration procedure being performed on both the IMU and a camera). In some example embodiments, each extrinsic calibration procedure comprises determining one or more corresponding extrinsic calibration parameters based on a calculated difference between sensed data of one of the plurality of components and sensed data of another one of the plurality of components.

In some example embodiments, the configuration module 406 is configured to configure an augmented reality function of the head mounted display 100 based on the determined intrinsic calibration parameters and the determined extrinsic calibration parameters. In some example embodiments, the configured augmented reality function is configured to cause the display of virtual content on the head mounted display 100 using the determined intrinsic and extrinsic calibration parameters in conjunction with the plurality of components.

In some example embodiments, the augmented reality function of the head mounted display 100 is implemented by the augmented reality module 412, which can reside on and be integrated into the head mounted display 100. Alternatively, the augmented reality function of the head mounted display can be reside on a computing device that is separate and remote from the head mounted display 100. For example, the augmented reality module 412 may reside on a remote server with which the head mounted display 100 communicates.

In some example embodiments, the configuring of the augmented reality function comprises configuring the augmented reality function to offset sensed data from the plurality of components based on the determined intrinsic and extrinsic calibration parameters.

In some example embodiments, configuring the augmented reality function comprises configuring the head mounted display based on the determined intrinsic calibration parameters and the determined extrinsic calibration parameters. In some example embodiments, configuring the head mounted display comprises configuring the plurality of components.

In some example embodiments, configuring the augmented reality function comprises configuring a computing device that is remote from the head mounted display and communicates with the head mounted display via wireless communication, the computing device being configured to provide the augmented reality function to the head mounted display.

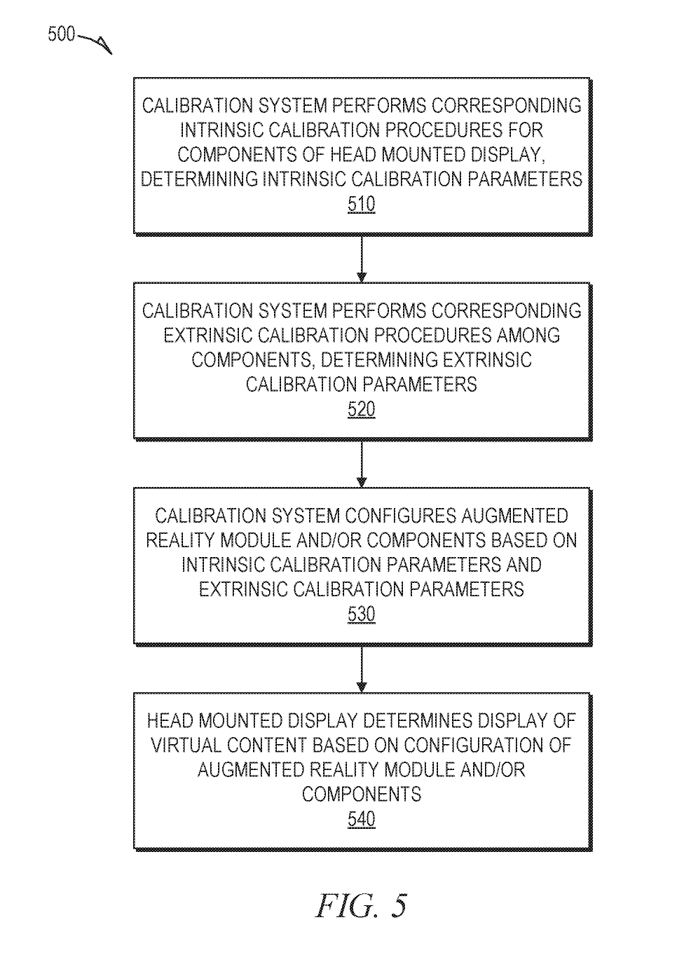

FIG. 5 is a flowchart illustrating a method 500 of head mounted display calibration, in accordance with some embodiments. The operations of method 500 can be performed by a system or modules of a system (e.g., calibration system 400 in FIG. 4).

At operation 510, a corresponding intrinsic calibration procedure is performed for each component in a plurality of components of a head mounted display independently of any calibration procedure for any of the other components in the plurality of components, with each corresponding intrinsic calibration procedure comprising determining one or more corresponding intrinsic calibration parameters for the corresponding component based on a calculated difference between sensed data of the corresponding component and reference data.

In some example embodiments, the plurality of components comprises an inertial measurement unit (IMU), a range sensor, a camera for eye tracking, and at least one externally-facing camera for capturing visual content external of the head mounted display. In some example embodiments, the plurality of components further comprises at least one of a projector and a display surface.

At operation 520, a plurality of extrinsic calibration procedures are performed among the plurality of components, with each extrinsic calibration procedure comprising determining one or more corresponding extrinsic calibration parameters based on a calculated difference between sensed data of one of the plurality of components and sensed data of another one of the plurality of components.

At operation 530, an augmented reality function of the head mounted display is configured based on the determined intrinsic calibration parameters and the determined extrinsic calibration parameters, with the configured augmented reality function being configured to cause the display of virtual content on the head mounted display using the determined intrinsic and extrinsic calibration parameters in conjunction with the plurality of components.

In some example embodiments, the configuring of the augmented reality function comprises configuring the augmented reality function to offset sensed data from the plurality of components based on the determined intrinsic and extrinsic calibration parameters.

In some example embodiments, configuring the augmented reality function comprises configuring the head mounted display based on the determined intrinsic calibration parameters and the determined extrinsic calibration parameters. In some example embodiments, configuring the head mounted display comprises configuring the plurality of components.

In some example embodiments, configuring the augmented reality function comprises configuring a computing device that is remote from the head mounted display and communicates with the head mounted display via wireless communication, the computing device being configured to provide the augmented reality function to the head mounted display.

It is contemplated that the operations of method 500 may incorporate any of the other features disclosed herein.

Example embodiments of intrinsic calibration procedures and extrinsic calibration procedures that can be incorporated into calibration system 400 of FIG. 4 and method 500 of FIG. 5 are discussed below. It is contemplated that other intrinsic calibration procedures and other extrinsic calibration procedures are also within the scope of the present disclosure.

### Calibration of Individual Sensors—Intrinsic Parameters

In some example embodiments, intrinsic calibration of each component of the head mounted display is performed.

### A) Camera Calibration

For camera calibration (e.g., calibration of an externally-facing camera that captures visual content external of the head mounted display), a planar calibration target can be placed in front of the camera to be calibrated. A group (e.g., 10 to 15) of steady pictures of the target is taken by the camera while moving it around to cover a full range of motion (mostly orientation). Software (e.g., Matlab) can be run to calculate the intrinsic parameters of the camera: focal length, aspect ratio, principle point, skew, and distortion parameters. The item for camera calibration can be a flat calibration target with rectangular grid points with precise known positions.

In some example embodiments, the statistical model of image projection error is derived based on the actual image re-projection errors, which can be used for combine camera and IMU for accurate tracking. In summary, the following calibration parameters can be obtained:

| Para- | Focal | Aspect | Principle | | Distortion | Projection |
|---|---|---|---|---|---|---|
| meters | length | ratio | point | Skew | Parameters | noise |
| Unit | image | N/A | image | N/A | N/A | image |
| | pixel | | pixel | | | pixel |

### B) IMU Calibration—Accelerometer and Gyroscope

A MEMS IMU chip can integrate both the accelerometer and the gyroscope. So, placement and movement can involve the whole IMU. One advantage of MEMS IMU is the lower cost and smaller form factor. The system can calibrate and compensate for errors so the performance can be significantly improved.

An important aspect of error compensation is to properly model the behavior of an IMU system while the model parameters can be obtained through adequate calibration. In general, the parameters that need calibration can include scale factor (sensor sensitivity), sensor bias, and axis misalignment, while the sensor noise can be properly modeled. In general, the following linear models can be adopted for MEMS gyroscope and accelerometer respectively:

\tilde{ω}=(1+S_{w})ω+B_{ω}+ε(ω)

and

\tilde{α}=(1+S_{α})α+B_{α}+ε(α).

In addition, the system can calibrate the dependency of the gyroscope upon acceleration. As a result, the model for gyroscope can be modified as follows:

\tilde{ω}=(1+S_{w})ω+B_{ω}+b_{α}α+ε(ω)

To make it more explicit for calibration considering misalignment of axes, the following matrix form for accelerometer can be obtained:

$$[ \begin{matrix}{\tilde{a}}_{x} \\ {\tilde{a}}_{y} \\ {\tilde{a}}_{z}\end{matrix} ] = [ \begin{matrix}( 1 + {s}_{x} ) & {m}_{xy} & {m}_{xz} \\ {m}_{yx} & ( 1 + {s}_{y} ) & {m}_{yz} \\ {m}_{xz} & {m}_{yz} & ( 1 + {s}_{z} )\end{matrix} ] [ \begin{matrix}{a}_{x} \\ {a}_{y} \\ {a}_{z}\end{matrix} ] + [ \begin{matrix}{b}_{x} \\ {b}_{y} \\ {b}_{z}\end{matrix} ]$$

In this matrix form, the misalignment matrix is in general form. As such, it includes two internal axis mis-alignment and placement misalignment errors of IMU on a reference calibration table. It is ideal to rule out the placement misalignment.

For MMES IMU, the most significant error source can be the bias and time-dependent bias drift: b=b_{cal}+b_{rand}(t). For example, the gyroscope has a random walk component that is difficult to compensate for even after laboratory calibration. Sensor fusion processing can be applied to carry out of on-line calibration. In addition, temperature introduced drifts on model parameters can be a big contribution factor.

Some static calibration tests that can be employed include, but are not limited to:
Six-position test (tumble test) where mounting the IMU on a level table with each sensitive axis pointing alternatively up and down. The six-position test (18 equations and 12 unknowns) allows the determination of bias, scale and misalignment determination for both gyroscope and accelerometer. The calibration result can use as a starting point for more accurate calibration.
Static rate test where constant angular rate is applied with IMU mounted on a motion simulation rate table. This test allows determination of scale, bias and g-dependent biases for gyroscope.
Multi-position test with a precision motion simulation table. This test allows for precise movement of IMU while the imperfections of gyroscope and accelerometer will be propagated as errors. For example, the mounting error of IMU onto rate table may be estimated by turn the table clockwise and counter clock wise through the same angle.

i) Gyroscope Calibration Procedure

Here, the IMU can be fixed on a rate table so that the gyroscope lies in the centroid of rotation to measure the orientation. The rate table is then rotated with different speeds, and both readings from the rate table and the IMU 12 to 24 hours are recorded for each rotation speed. Software (e.g., Matlab) can be run to calculate the intrinsic parameters of the gyroscope: scale, bias, bias drift and noise.

In summary, the following calibration parameters can be obtained:

| Parameters | Scale | Bias | Bias drift | Noise |
|---|---|---|---|---|
| Unit | /g | rad/s | rad/s | rad/s |

### ii) Accelerometer Calibration Procedure

Here, the IMU can be fixed on a rate table with a few different distances away from the table centroid. For each fixation, the rate table is rotated with different speeds for 12 to 24 hours and both readings from the rate table and the IMU are recorded. Software (e.g., Matlab) can be run to calculate the intrinsic parameters of the gyroscope: scale, bias, bias drift and noise. In summary, the following calibration parameters can be obtained:

| Parameters | Scale | Bias | Bias drift | Noise |
|---|---|---|---|---|
| Unit | /(deg/s) | m/s² | m/s² | m/s² |

iii) Calibration Equipment

For normal application, the IMU can perform around 1G of acceleration. As such, a motion simulation rate table can be used that can provide accurate readings of rotation speed and acceleration up to 1 G.

### C) Range Sensor Calibration

In some example embodiments, the recommended on-line factory calibration provided by manufactures of range sensors is employed.

D) Projector/Display Calibration

In some example embodiments, projector/display calibration is used to project an image to display a pattern with desired intensity and geometry. Both geometric and photometric correction can be applied to images for display. A factory calibration may be performed where a calibrated camera is placed in front of a camera calibration target to capture images.

First, a camera can be calibrated for the purpose of geometric distortion correction. The camera can then be used to capture displayed image of an ideal calibration target. By comparing these images (after applying geometric correction) with the ideal pattern, information on how to create an ideal displayed image by tweaking the ideal image before display can be obtained.

### Calibration Among Sensors—Extrinsic Parameter

In the following table, available sensors and potential needs for calibration among them or against the NavRig coordinate system are listed. The table lists potential extrinsic calibrations among components. Two main coordinate systems that can be used are: IMU coordinate system and Display coordinate system. In some example embodiments, for navigation purpose, IMU coordinate system is the reference. In some example embodiments, for display purpose, Display coordinate system is the reference.

| | | | Range | Display/ | Eye |
|---|---|---|---|---|---|
| Calibration | Camera | IMU | Sensor | Projector | (tracker) |
| Camera | Camera1-camera2 | | | | |
| IMU | IMU-Camera | N/A | | | |
| | calibration | | | | |
| Range | Range-Camera | | N/A | | |
| Sensor | | | | | |
| Display/ | Display-Camera | | | Display- | |
| Projector | | | | Display | |
| Eye | (Eye-display + | | | Eye- | N/A |
| (tracker) | Display-camera) | | | Display | |

In practice, there are many ways to calibrate. One component can be selected as the reference and its CS as the NavRig CS, potentially with known rotation and translation. This way, the system only needs to calibrate all the other components against this reference component. Another calibration strategy is to group components into subsystem and then calibrate among subsystems.

### A) Calibration of NavRig—Rig of Non-Overlapping Cameras

Two approaches for this calibration are provided herein. The key criterion here is to select one that is easy to carry out in practice without introducing unintended errors, for example, calibration targets unstable during operation.

The first approach is to use four identical calibration targets as previously described. In operation, the four calibration targets are fixed and the rig of cameras is moved around so that the relative pose of target-camera changes.

Pictures of all four cameras are taken simultaneously. In a software step: first run single camera calibration for each camera to get various poses with respect to their own target, and then solve the unknown (e.g., the relative poses among the four cameras, and relative poses among the four calibration targets).

The second approach is to use just one calibration target but add a planar mirror. In operatione, the mirror is moved around so the relative pose of target-mirror-camera changes. Pictures are taken of single camera or multiple cameras as long as all grid points are visible to all the cameras. In a software step: first run single camera calibration for each camera to get various poses with respect to the same target There are additional unknowns (e.g., the mirror poses) that can be solved or determined. After this, relative poses among the four cameras are readily available.

The calibration equipment can include a flat calibration target with rectangular grid points with precise known positions. Image capturing system and Matlab to run the calibration software can be employed. The calibration equipment can include four identical calibration targets for the first approach, as well as an image capturing system to capture four cameras at the same time. For the second approach, one calibration target can be used with an additional mirror.

### B) Calibration of Cameras and IMU

In operation, this calibration can be similar to calibration of rig of non-overlapping cameras. The system takes additional readings from IMU. However, this operation should be smooth and quick so the drift and bias of IMU (accelerometer and gyroscope) is minimized. To further help reduce the IMU errors, the NavRig can be attached to a rate table where rotation speed can be monitored and compensated. The rate table can be programmed to move to different canonical positions where video images can be captured by the cameras facing the camera calibration targets. Such moves should be very fast while remaining stationary for taking pictures. Calibration target of rig of non-overlapping cameras and rate table can be used.

### C) Calibration of Range and Video

The goal of range-camera calibration is to obtain the 3D transformation (e.g., the relative pose of the camera coordinate system with respect to the coordinate system of the range sensor). With this calibration information, the system can transform the 3D points sensed by the range sensors and project them and overlay onto the images captured by the video camera.

In some example embodiments, the cameras and range are first calibrated, then the cameras and range sensors are calibrated by first taking shots at targets. For example, the system can use the flat camera calibration targets. In this case, it is hard to extract accurate location of each pixel from the range sensor. Rather, the system can take multiple shots of one calibration target or several targets at once. Then based on multiple surface orientations, the system can estimate the 3D transformation. Multiple camera calibration targets can be used.

### D) Calibration of Eye and Display

The goal of eye-display calibration is to obtain the transformation between eye and projector/display so we can project/display image at the right place. This is important for optical see-through display. This is also critical for eye tracking that can be used to indicate whether you are looking at with potential right-on-the-spot overlay of information. For example, the system can project a 3D model into the display that can overlay with actual scene. A factory calibration may be an averaged calibration for a group of representative users. If needed, online calibration for individual user involves running on-line calibration procedure where geometrically widespread markers are displayed on the screen for the user to aim and focus.

### E) Calibration of Display and Video

The goal of display-camera calibration is to obtain the transformation (3D rigid and perspective) between video camera and projector/display as if they are from the same point of view. This transformation can be applied to the images captured by the camera for display.

In combination with eye-display calibration, the system can have eye-camera calibration. As a result, the system can look at a specific site and render/overlay the scene captured a few days ago to see potential scene change. A factory calibration may be performed where a canonical eye (Wide FOV camera) is placed in a canonical position of human eye and capture the composite images (live and captured) of a camera calibration target.

The system may turn off the display to capture just the real-world image. And then the system can turn off light and turn on the display to capture just the displayed image. The difference of these two images is due to the transformation we need to estimate. The system can augment the factory calibration by carrying out the on-line eye-display calibration that compensate for the difference between individual eyes and the canonical eye. In some example embodiments, a calibrated wide field of view camera serves as two eyes.

### F) Calibration of Display1 and Display2

To obtain large field of view display, the system can use more than one projector/display modules. To create a feel of just one big display, the system obtains the transformation (3D rigid and perspective) between two projector/display modules, hence the display-display calibration. In addition to geometric compensation, photometric calibration also needs to be performed to remove intensity variation. Both geometric and photometric transformations can be applied to images for display. This can be in combination with individual display correction.

A factory calibration may be performed where we put a canonical eye (Wide FOV camera) in a canonical position of human eye and capture the projected images of a calibration target. The system can augment the factory calibration by carrying out the on-line eye-display calibration that compensate for the difference between individual eyes and the canonical eye. In some example embodiments, a calibrated wide field of view camera serves as two eyes.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled.

A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

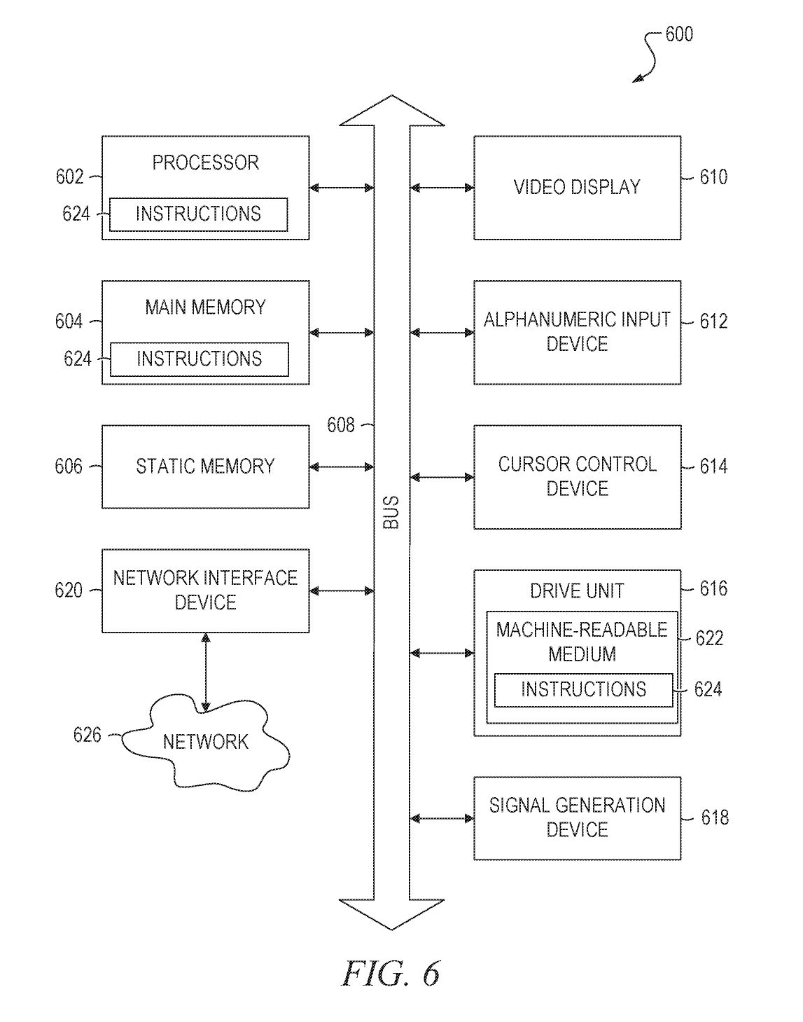

FIG. 6 is a block diagram of a machine in the example form of a computer system 600 within which instructions 624 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a smartphone, a tablet computer, a set-top box (STB), a Personal Digital Assistant (PDA), a web appliance, a network router, switch or bridge, a head-mounted display or other wearable device, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610. The computer system 600 may also include an alphanumeric input device 612 (e.g., a keyboard), a user interface (UI) navigation (or cursor control) device 614 (e.g., a mouse), a disk drive unit 616, a signal generation device 618 (e.g., a speaker) and a network interface device 620.

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
at least one processor; and
a non-transitory computer-readable medium storing executable instructions that, when executed, cause the at least one processor to perform operations comprising:
performing a corresponding intrinsic calibration procedure for each component in a plurality of components of a head mounted display independently of any calibration procedure for any of the other components in the plurality of components, each corresponding intrinsic calibration procedure comprising determining one or more corresponding intrinsic calibration parameters for the corresponding component based on a calculated difference between sensed data of the corresponding component and reference data;
performing a plurality of extrinsic calibration procedures among the plurality of components, each extrinsic calibration procedure comprising determining one or more corresponding extrinsic calibration parameters based on a calculated difference between sensed data of one of the plurality of components and sensed data of another one of the plurality of components; and
configuring an augmented reality function of the head mounted display based on the determined intrinsic calibration parameters and the determined extrinsic calibration parameters, the configured augmented reality function being configured to cause the display of virtual content on the head mounted display using the determined intrinsic and extrinsic calibration parameters in conjunction with the plurality of components.

2. The system of claim 1, wherein the configuring of the augmented reality function comprises configuring the augmented reality function to offset sensed data from the plurality of components based on the determined intrinsic and extrinsic calibration parameters.

3. The system of claim 1, wherein the plurality of components comprises an inertial measurement unit (IMU), a range sensor, a camera for eye tracking, and at least one externally-facing camera for capturing visual content external of the head mounted display.

4. The system of claim 3, wherein the plurality of components further comprises at least one of a projector and a display surface.

5. The system of claim 1, wherein configuring the augmented reality function comprises configuring the head mounted display based on the determined intrinsic calibration parameters and the determined extrinsic calibration parameters.

6. The system of claim 5, wherein configuring the head mounted display comprises configuring the plurality of components.

7. The system of claim 1, wherein configuring the augmented reality function comprises configuring a computing device that is remote from the head mounted display and communicates with the head mounted display via wireless communication, the computing device being configured to provide the augmented reality function to the head mounted display.

8. A computer-implemented method comprising:
performing a corresponding intrinsic calibration procedure for each component in a plurality of components of a head mounted display independently of any calibration procedure for any of the other components in the plurality of components, each corresponding intrinsic calibration procedure comprising determining one or more corresponding intrinsic calibration parameters for the corresponding component based on a calculated difference between sensed data of the corresponding component and reference data;
performing a plurality of extrinsic calibration procedures among the plurality of components, each extrinsic calibration procedure comprising determining one or more corresponding extrinsic calibration parameters based on a calculated difference between sensed data of one of the plurality of components and sensed data of another one of the plurality of components; and
configuring, by a machine having a memory and at least one processor, an augmented reality function of the head mounted display based on the determined intrinsic calibration parameters and the determined extrinsic calibration parameters, the configured augmented reality function being configured to cause the display of virtual content on the head mounted display using the determined intrinsic and extrinsic calibration parameters in conjunction with the plurality of components.

9. The computer-implemented method of claim 8, wherein the configuring of the augmented reality function comprises configuring the augmented reality function to offset sensed data from the plurality of components based on the determined intrinsic and extrinsic calibration parameters.

10. The computer-implemented method of claim 8, wherein the plurality of components comprises an inertial measurement unit (IMU), a range sensor, a camera for eye tracking, and at least one externally-facing camera for capturing visual content external of the head mounted display.

11. The computer-implemented method of claim 10, wherein the plurality of components further comprises at least one of a projector and a display surface.

12. The computer-implemented method of claim 8, wherein configuring the augmented reality function comprises configuring the head mounted display based on the determined intrinsic calibration parameters and the determined extrinsic calibration parameters.

13. The computer-implemented method of claim 12, wherein configuring the head mounted display comprises configuring the plurality of components.

14. The computer-implemented method of claim 8, wherein configuring the augmented reality function comprises configuring a computing device that is remote from the head mounted display and communicates with the head mounted display via wireless communication, the computing device being configured to provide the augmented reality function to the head mounted display.

15. A non-transitory machine-readable storage device storing a set of instructions that, when executed by at least one processor, causes the at least one processor to perform operations comprising:
performing a corresponding intrinsic calibration procedure for each component in a plurality of components of a head mounted display independently of any calibration procedure for any of the other components in the plurality of components, each corresponding intrinsic calibration procedure comprising determining one or more corresponding intrinsic calibration parameters for the corresponding component based on a calculated difference between sensed data of the corresponding component and reference data;
performing a plurality of extrinsic calibration procedures among the plurality of components, each extrinsic calibration procedure comprising determining one or more corresponding extrinsic calibration parameters based on a calculated difference between sensed data of one of the plurality of components and sensed data of another one of the plurality of components; and
configuring an augmented reality function of the head mounted display based on the determined intrinsic calibration parameters and the determined extrinsic calibration parameters, the configured augmented reality function being configured to cause the display of virtual content on the head mounted display using the determined intrinsic and extrinsic calibration parameters in conjunction with the plurality of components.

16. The storage device of claim 15, wherein the configuring of the augmented reality function comprises configuring the augmented reality function to offset sensed data from the plurality of components based on the determined intrinsic and extrinsic calibration parameters.

17. The storage device of claim 15, wherein the plurality of components comprises an inertial measurement unit (IMU), a range sensor, a camera for eye tracking, and at least one externally-facing camera for capturing visual content external of the head mounted display.

18. The storage device of claim 17, wherein the plurality of components further comprises at least one of a projector and a display surface.

19. The storage device of claim 15, wherein configuring the augmented reality function comprises configuring the head mounted display based on the determined intrinsic calibration parameters and the determined extrinsic calibration parameters.

20. The storage device of claim 19, wherein configuring the head mounted display comprises configuring the plurality of components.
